(19) United States
(12) Patent Application Publication
(10) Pub. No.: US 2022/0284893 A1
(43) Pub. Date: Sep. 8, 2022

(54) WIRELESS LIGHTING CONTROL SYSTEMS FOR INTELLIGENT LUMINAIRES

(71) Applicant: ABL IP Holding LLC, Atlanta, GA (US)

(72) Inventors: Mohammad Bani Hani, Glenview, IL (US); Charles Jeffrey Spencer, Wilmette, IL (US); Yan Rodriguez, Suwanee, GA (US); Charles Richard Shoop, JR., Blythewood, SC (US)

(21) Appl. No.: 17/193,487

(22) Filed: Mar. 5, 2021

(51) Int. Cl. G10L 15/22; G08C 17/02; H04W 4/80; G10L 15/30; H04R 1/08; G10L 15/08; G06F 3/16; H05B 47/12; H05B 47/19

(52) U.S. Cl. CPC G10L 15/22; G08C 17/02; H04W 4/80; G10L 15/30; H04R 1/08; G10L 15/08; G06F 3/167; H05B 47/12; H05B 47/19; H04W 84/12

(57) ABSTRACT

A wireless controller system includes a cradle device and a wireless controller. The cradle device includes a power input that receives power from a power source, a first communication module that communicates wirelessly with one or more devices remote from the cradle device, and a first electrical interface that provides a charging power to the wireless controller. The wireless controller includes a display device that displays lighting system control features. The wireless controller also includes a second communication module that communicates wirelessly with the first communication module of the cradle device. Additionally, the wireless controller includes a microphone that receives a voice input to interact with at least one voice assistant, and a second electrical interface that generates a power link with the first electrical interface of the cradle device to receive the charging power from the cradle device.

### TECHNICAL FIELD

This disclosure relates generally to systems to control luminaire operations. More specifically, but not by way of limitation, this disclosure relates to wireless lighting control systems that enable control of luminaire operations using interactive user interfaces.

### BACKGROUND

Connected lighting can include lamps, luminaires, and controls that communicate through technologies such as Wi-Fi, Bluetooth, cellular protocols, or any other communication protocols to provide an increased level of control of the lamps, luminaire, and controls. The connected lighting may be controlled with external controllers, such as smartphone applications, web portals, voice-activated devices, other control mechanisms, or any combination thereof. Control of the connected lighting through general purpose devices, such as smartphones and computing devices, may limit operability of the connected lighting to users that have the ability to link the general purpose device to the connected lighting, such as through a computing application. Control of the connected lighting using voice commands, such as with a voice-activated device, may be limited based on how close a user is to a connected lighting component that includes the voice-activated device.

### SUMMARY

Certain aspects involve wireless lighting control systems that enable control of luminaire operations using interactive user interfaces. For instance, a wireless controller system includes a cradle device and a wireless controller. The cradle device includes a power input that receives power from a power source, a first communication module that communicates wirelessly with one or more devices remote from the cradle device, and a first electrical interface that provides a charging power to the wireless controller. The wireless controller includes a display device that displays lighting system control features. The wireless controller also includes a second communication module that communicates wirelessly with the first communication module of the cradle device. Additionally, the wireless controller includes a microphone that receives a voice input to interact with at least one voice assistant, and a second electrical interface that generates a power link with the first electrical interface of the cradle device to receive the charging power from the cradle device.

In an additional example, a wireless controller includes a display device that displays lighting system control features, a communication module that communicates wirelessly with one or more devices remote from the wireless controller, and at least one sensor that senses at least one environmental condition at the wireless controller. Further, the wireless controller includes a processor and a non-transitory memory device communicatively coupled to the processor including instructions that are executable by the processor to perform operations. The operations include receiving an indication of the at least one environmental condition from the at least one sensor and automatically controlling at least one intelligent luminaire using the indication of the at least one environmental condition from the at least one sensor.

In an additional example, a cradle device includes a power input configured to receive power from a power source. The cradle device also includes a first communication module that communicates wirelessly with at least one wireless controller remote from the cradle device and a second communication module that communicates wirelessly with at least one intelligent luminaire to control operation of the intelligent luminaire. Further, the cradle includes a first electrical interface that provides a charging power to the at least one wireless controller.

These illustrative aspects are mentioned not to limit or define the disclosure, but to provide examples to aid understanding thereof. Additional aspects are discussed in the Detailed Description, and further description is provided there.

### BRIEF DESCRIPTION OF THE DRAWINGS

Features, aspects, and advantages of the present disclosure are better understood when the following Detailed Description is read with reference to the accompanying drawings.

FIG. 1 depicts a block diagram of a light system including intelligent luminaires, according to certain aspects of the present disclosure.

FIG. 2 depicts a schematic representation of a wireless controller of the light system of FIG. 1, according to certain aspects of the present disclosure.

FIG. 3 depicts a block diagram representation of the wireless controller of FIG. 2, according to certain aspects of the present disclosure.

FIG. 4A depicts a schematic representation of a cradle for the wireless controller of FIG. 2, according to certain aspects of the present disclosure.

FIG. 4B depicts a schematic representation of the wireless controller of FIG. 2 installed within the cradle of FIG. 4A, according to certain aspects of the present disclosure.

FIG. 5 depicts a block diagram representation of the cradle of FIGS. 4A and 4B, according to certain aspects of the present disclosure.

FIG. 6 depicts a diagram of a group of compatible connected fixtures using cloud connectivity for voice and lighting control, according to certain aspects of the present disclosure.

FIG. 7 depicts a diagram of a group of compatible connected fixtures using localized control, according to certain aspects of the present disclosure.

FIG. 8 depicts an example of a process for performing voice control operations on a light system, according to certain aspects of the present disclosure.

FIG. 9 depicts a diagram of a group of compatible connected fixtures using peer-to-peer and device-to-device communication for lighting control, according to certain aspects of the present disclosure.

FIG. 10 depicts a diagram of distributed microphones for far field barge-in performance improvement, according to certain aspects of the present disclosure.

FIG. 11 depicts a data flow of far field barge-in, according to certain aspects of the present disclosure.

### DETAILED DESCRIPTION

The present disclosure relates to systems that that enable control of luminaire operations using interactive user interfaces. As explained above, devices currently used to control certain types of connected lighting systems may suffer from accessibility issues. As a result, access to control of the connected lighting system may be limited.

The presently disclosed wireless controller system addresses these issues by providing a wireless controller and a cradle that are able to wirelessly control the connected lighting system. The wireless controller system may include, for example, the wireless controller that is battery operated. The wireless controller may be charged within the cradle. Additionally, the wireless controller and the cradle may communicate with the connected lighting system through a cloud based control module, through a localized control module (e.g., using a local network not connected to the internet), through peer-to-peer and device-to-device communication, or any combination thereof.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

### Intelligent Luminaire Light System

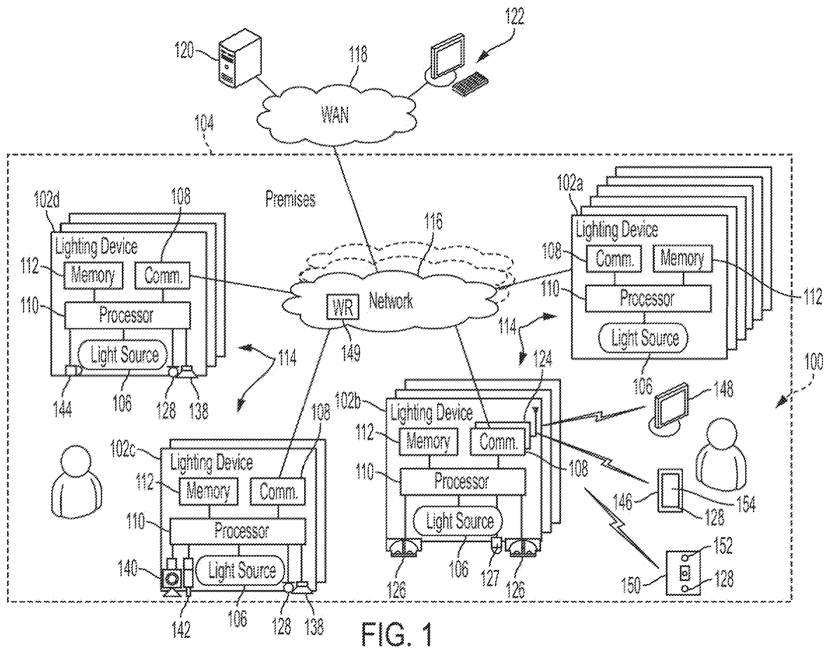

FIG. 1 is a block diagram depicting a light system 100. The illustrated light system 100 includes a number of intelligent luminaires 102, such as recessed lights, pendant lights, fluorescent fixtures, lamps, etc. The intelligent luminaires 102 are represented in several different configurations. In another example, the intelligent luminaires 102 may all include the same configuration. Additionally, one or more of the intelligent luminaires 102 may be replaced by other connected devices (i.e., devices that are controllable through wired or wireless communication by other devices).

The intelligent luminaires 102 illuminate a service area to a level useful for a human in or passing through a space. One or more of the intelligent luminaires 102 in or on a premises 104 served by the light system 100 may have other lighting purposes, such as signage for an entrance to the premises 104 or to indicate an exit from the premises 104. The intelligent luminaires may also be usable for any other lighting or non-lighting purposes.

In an example, each of the intelligent luminaires 102 include a light source 106, a communication interface 108, and a processor 110 coupled to control the light source 106. The light sources 106 may be any type of light source suitable for providing illumination that may be electronically controlled. The light sources 106 may all be of the same type (e.g., all formed by some combination of light emitting diodes), or the light sources may have different types of light sources 106.

The processor 110 is coupled to control communications using the communication interface 108 and a network link with one or more others of the intelligent luminaires 102 and is able to control operations of at least the respective intelligent luminaire 102. The processor 110 may be implemented using hardwired logic circuitry, but in an example, the processor 110 may also be a programmable processor such as a central processing unit (CPU) of a microcontroller or a microprocessor. In the example of FIG. 1, each intelligent luminaire 102 also includes a memory 112, which stores programming for execution by the processor 110 and data that is available to be processed or has been processed by the processor 110. The processors 110 and memories 112 in the intelligent luminaires 102 may be substantially the same throughout the devices 114 throughout the premises 104, or different devices 114 may have different processors 110, different amounts of memory 112, or both depending on differences in intended or expected processing needs.

In an example, the intelligence (e.g., the processor 110 and the memory 112) and the communications interface(s) 108 are shown as integrated with the other elements of the intelligent luminaire 102 or attached to the fixture or other element that incorporates the light source 106. However, for some installations, the light source 106 may be attached in such a way that there is some separation between the fixture or other element that incorporates the electronic components that provide the intelligence and communication capabilities. For example, the communication interface(s) 108 and, in some examples, the processor 110 and the memory 112 may be elements of a separate device or component that is coupled to or collocated with the light source 106.

The light system 100 is installed at the premises 104. The light system 100 may include a data communication network 116 that interconnects the links to and from the communication interfaces 108 of the intelligent luminaires 102. In an example, interconnecting the intelligent luminaires 102 across the data communication network 116 may provide data communications amongst the intelligent luminaires 102. Such a data communication network 116 may also provide data communications for at least some of the intelligent luminaires 102 via a data network 118 outside the premises, shown by way of example as a wide area network (WAN), so as to allow the intelligent luminaires 102 or other connected devices at the premises 104 to communicate with outside devices such as a server or host computer 120 or a user terminal device 122. The wide area network 118 outside the premises 104 may be an intranet or the Internet, for example.

The intelligent luminaires 102, as well as any other equipment of the light system 100 or that uses the communication network 116 in a service area of the premises 104, connect together with and through the network links and any other media forming the communication network 116. For lighting operations, the intelligent luminaires 102 (and other system elements) for a given service area are coupled together for network communication with each other through data communication media to form a portion of a physical data communication network. Similar elements in other service areas of the premises are coupled together for network communication with each other through data communication media to form one or more other portions of the physical data communication network at the premises 104. The communication interface 108 in each intelligent luminaire 102 in a particular service area may be of a physical type and operate in a manner that is compatible with the physical media and electrical protocols implemented for the particular service area or throughout the premises 104. Although the communication interfaces 108 are shown communicating to and from the communication network 116 using lines, such as wired links or optical fibers, some or all of the communication interfaces 108 may use wireless communications media such as optical or radio frequency wireless communication.

Various network links within a service area, amongst devices in different areas or to wider portions of the communication network 116 may utilize any convenient data communication media, such as power line wiring, separate wiring such as coaxial or Ethernet cable, optical fiber, free-space optical, or radio frequency wireless (e.g., Bluetooth or Wi-Fi). The communication network 116 may utilize combinations of available networking technologies. Some or all of the network communication media may be used by or made available for communications of other gear, equipment, or systems within the premises 104. For example, if combinations of Wi-Fi and wired or fiber Ethernet are used for the lighting system communications, the Wi-Fi and Ethernet may also support communications for various computer and/or user terminal devices that the occupant(s) may want to use in the premises 104. The data communications media may be installed at the time as part of installation of the light system 100 at the premises 104 or may already be present from an earlier data communication installation. Depending on the size of the communication network 116 and the number of devices and other equipment expected to use the communication network 116 over the service life of the communication network 116, the communication network 116 may also include one or more packet switches, routers, gateways, etc.

In addition to the communication interface 108 for enabling a lighting device to communicate via the communication network 116, some of the devices 11 may include an additional communication interface, shown as a wireless interface 124 in the intelligent luminaire 102b. The additional wireless interface 124 allows other elements or equipment to access the communication capabilities of the light system 100, for example, as an alternative user interface access or for access through the light system 100 to the WAN 118.

The host computer or server 120 can be any suitable network-connected computer, tablet, mobile device or the like programmed to implement desired network-side functionalities. Such a device may have any appropriate data communication interface to link to the WAN 118. Alternatively or in addition, the host computer or server 120 may be operated at the premises 104 and utilize the same networking media that implements the data communication network 116.

The user terminal device 122 may be implemented with any suitable processing device that can communicate and offer a suitable user interface. The user terminal device 122, for example, is shown as a desktop computer with a wired link into the WAN 118. Other terminal types, such as laptop computers, notebook computers, netbook computers, and smartphones may serve as the user terminal device 122. Also, although shown as communicating via a wired link from the WAN 118, such a user terminal device may also or alternatively use wireless or optical media, and such a device may be operated at the premises 104 and utilize the same networking media that implements the data communication network 116.

The external elements, represented generally by the server or host computer 120 and the user terminal device 122, which may communicate with the intelligent luminaires 102 of the system 100 at the premises 104, may be used by various entities or for various purposes in relation to operation of the light system 100 or to provide information or other services to users within the premises 104.

In the example of the light system 100, at least one of the intelligent luminaires 102 may include a user input sensor capable of detecting user activity related to user inputs without requiring physical contact of the user. Further, at least one of the intelligent luminaires 102 may include an output component that provides information output to the user.

Some of the intelligent luminaires 102 may not have user interface related elements. In the example of the light system 100, each of the intelligent luminaires 102a includes a light source 106, a communication interface 108 linked to the communication network 116, and a processor 110 coupled to control the light source 106 and to communicate via the communication interface. Such intelligent luminaires 102a may include lighting related sensors (not shown), such as occupancy sensors or ambient light color or level sensors; but the intelligent luminaires 102a do not include any user interface components for user input or for output to a user (other than control of the respective light source 106). The processors of the intelligent luminaires 102a are programmable to control lighting operations, for example, to control the light sources 106 of the intelligent luminaires 102a in response to commands received from the communication network 116 and the communication interfaces 108.

Other examples of the intelligent luminaires 102b, 102c, and 102d may include one or more user interface components. Although three examples are shown, it is envisaged that still other types of interface components or arrangements thereof in various intelligent lighting devices may be used in any particular implementation of a system like the light system 100. Any one intelligent luminaire that includes components to support the interactive user interface functionality of the light system 100 may include an input sensor type user interface component, an output type user interface component, or a combination of one or more input sensor type user interface components with one or more output type user interface components.

Each of some number of intelligent luminaires 102b at the premises 104 may include one or more sensors 126. The intelligent luminaires 102b can be in one or more rooms or other service areas at the premises 104. In the intelligent luminaires 102b, each of the sensors 126 is configured for detection of intensity of received light and to support associated signal processing to determine direction of incident light. A particular example of the sensor 126 that can be used as an input device for determining direction and intensity of incident light received by the sensor 126 is a quadrant hemispherical light detector or “QHD.” The sensors 126 may detect light in some or all of the visible portion of the spectrum or in other wavelength bands, such as infrared (IR) or ultraviolet (UV). By using two or more such sensors 126 in the same or a different intelligent luminaire 102b illuminating the same service area, it is possible to detect position of an illuminated point or object in three-dimensional space relative to known positions of the sensors 126. By detecting position of one or more points over time, it becomes possible to track motion within the area illuminated by the intelligent luminaire(s) 102b and monitored for user input by the sensors 126, for example, as a gestural user input. Although two sensors 126 are shown on one intelligent luminaire 102b, there may be more sensors 126 or there may be a single sensor 126 in each intelligent luminaire 102b amongst some number of the intelligent luminaires 102b illuminating a particular service area of the premises 104.

In an example, at least one of the intelligent luminaires 102b also includes a lighting related sensor 127. Although shown in the intelligent luminaire 102b for purposes of discussion, such a sensor may be provided in any of the other intelligent luminaires 102, in addition or as an alternative to deployment of the sensor 127 in a lighting intelligent luminaire 102b. Examples of such lighting related sensors 127 include occupancy sensors, device output (level or color characteristic, which may include light color, light temperature, or both) sensors, and ambient light (level or color characteristic, which may include light temperature, or both) sensors. The sensor 127 may provide a condition input for general lighting control (e.g., to turn on or off the intelligent luminaires 102 or adjust outputs of the light sources 106). However, sensor input information from the sensor 127 also or alternatively may be used as another form of user input, for example, to refine detection and tracking operations responsive to signals from the sensors 126.

In the example of the light system 100, each of the intelligent luminaires 102c and one or more of the intelligent luminaires 102d in one or more rooms or other service areas of the premises 104 may support audio input and audio output for an audio based user interface functionality. Also, audio user interface components may be provided in other intelligent luminaires 102 that are different from those deploying the video user interface components. For convenience, the audio input and output components and the video input and output components are shown together in each of the intelligent luminaires 102c, one or more of which may be deployed with other lighting devices in some number of the services areas within premises 104.

In the example of FIG. 1, each intelligent luminaire 102c, one or more of the intelligent luminaires 102d, or a combination thereof includes an audio user input sensor such as a microphone 128. Any type of microphone capable of detecting audio user input activity, for example, for speech recognition of verbal commands or the like, may be used. Although the audio output may be provided in different devices 114, each of the intelligent luminaires 102c or 102d may include an audio output component such as one or more speakers 138 that provide information output to the user. Where the speaker 138 is provided, there may be a single speaker 138 or there may be a plurality of speakers 138 in each respective intelligent luminaire 102.

The audio input together with lighting control and audio information output implement an additional form of interactive user interface. The user interface related operation includes selectively controlling a lighting operation of at least some number of the intelligent luminaires 102 as a function of a processed user input. The interface related operation may also include either control of a non-lighting-related function as a function of a processed user input, or an operation to obtain and provide information as a response to a user input as an output via the output component. For example, a user audio input (e.g., a voice command) may be processed to control a non-lighting device 114 (e.g., an HVAC unit, a washer, a dryer, etc.) that is communicatively connected to the communication network 116. Further, the intelligent luminaires 102 may respond with audible information when the microphone 128 receives a user request for information (e.g., a weather update, movie show times, etc.).

A mute functionality of the microphone 128 may be performed remotely using a companion mobile application (e.g., on a wireless controller 146). The mute functionality may preserve user privacy by enabling the user to mute voice assistant services of a virtual assistant enabled luminaire. In an example where the intelligent luminaire 102 is ceiling mounted and far away from the normal user, a hardware mute button may not be practical for an occupant of a room containing the intelligent luminaire 102. Using a software based mute button will provide a mechanism for the user to shut down the microphones 128 on the intelligent luminaire 102 to stop a voice service from listening to the user.

Although shown for illustration purposes in the intelligent luminaire 102c, image-based input and/or output components may be provided together or individually in any others of the intelligent luminaires 102 that may be appropriate for a particular installation. Although referred to at times as “video,” the image-based input and/or output may utilize still image input or output or may use any appropriate form of motion video input or output. In the example of the light system 100, each of several of the intelligent luminaires 102d in one or more rooms of the premises 104 also supports image input and output for a visual user interface functionality.

For the visual user interface functionality an intelligent luminaire 102c includes at least one camera 140. The camera 140 could be a still image pickup device controlled to capture some number of images per second, or the camera 140 could be video camera. By using a number of cameras 140 to capture images of a given service area, it is possible to process the image data to detect and track user movement in the area, for example, to identify user input gestures. The multiple cameras 140 could be in a single intelligent luminaire 102c or could be provided individually in two or more of the lighting devices that illuminate a particular room or other service area. The image capture may also support identification of particular individuals. For example, individuals may be identified using facial recognition and associated customization of gesture recognition or user responsive system operations.

A visual output component in the intelligent luminaire 102c may be a projector 142, such as a pico-projector. The visual output component may take other forms, such as an integral display as part of or in addition to the light source. The projector 142 can present information in a visual format, for example, as a projection on a table, a desktop, a wall, or the floor. Although shown in the same intelligent luminaire 102c as the camera 140, the projector 142 may be in a different intelligent luminaire 102.

One or more of the processors 110 in the intelligent luminaires 102 are able to process user inputs detected by the user input sensor(s), such as the visual sensors 126, 128, 140, the microphone(s) 128, or a combination thereof. Other non-contact sensing technologies may also be used (e.g., ultrasound) instead of or in combination with the input sensors discussed above. The processing of sensed user inputs may relate to control operations of the intelligent luminaires in one or more areas of the premises 104. For example, the processing may detect spoken commands or relevant gestural inputs from a user to control the intelligent lighting devices in an area in which the user is located (e.g., to turn lights ON/OFF, to raise or lower lighting intensity, to change a color characteristic of the lighting, or a combination thereof).

In addition to lighting control functions, such as mentioned here by way of example, one or more of the processors 110 in the intelligent luminaires 102 may be able to process user inputs so as to enable the light system 100 to obtain and present requested information to a user at the premises 104. By way of an example of such additional operations, the light system 100 may also enable use of the intelligent luminaires 102 to form an interactive user interface portal for access to other resources at the premises 21 (e.g., on other non-lighting devices in other rooms at the premises) or enable access to outside network resources such as on the server 120 or a remote terminal 122 (e.g., via the WAN 118).

Any one or more of the intelligent luminaires 102 may include a sensor 144 for detecting operation of the light source 106 within the respective intelligent luminaire 102. The sensor 144 may sense a temperature of the light source 106 or sense other components of the intelligent luminaire 102. The sensor 144 may also sense an optical output of the light source 106 (e.g., a light intensity level or a color characteristic). The sensor 144 may provide feedback as to a state of the light source 106 or other component of the intelligent luminaire 102, which may be used as part of the general control of the intelligent luminaires 102.

The sensor 144 may also be a wireless or wired environmental monitoring element, and the intelligent luminaire 102 may include one or more of the sensors 144. Monitoring of environmental parameters using the intelligent luminaire 102 can provide information about the surrounding environment and the human occupancy status of a space where the intelligent luminaire 102 is installed. In some examples, the intelligent luminaire 102 may be referred to as a smart connected luminaire. The term “smart connected luminaire” may refer to a luminaire that is capable of communicating with other devices (e.g., environmental sensors, internet of things (IoT) devices, other luminaires, the internet, etc.). Further, the smart connected luminaire may be capable of receiving or sending signals from sensors or transducers of other IoT devices, processing the signals, and performing operations based on the processed signals.

In an example, the sensors 144 (e.g., detectors and sensors) may be integral within the intelligent luminaire 102, the sensors 144 may be wirelessly coupled to the intelligent luminaire 102, or the sensors 144 may be in wired communication with the intelligent luminaire 102. The sensors 144 provide environmental monitoring statuses to the intelligent luminaire 102. In turn, the intelligent luminaire 102 may provide the environmental monitoring statuses to a cloud computing service (e.g., at the server 120) for analytics. For example, the intelligent luminaire 102 may act as a wireless local area network (LAN) access point to all smart wireless LAN or Bluetooth capable detectors and sensors capable of connecting to the intelligent luminaire 102. In this manner, each detector or sensor may be monitored for its data, which may include and not be limited to temperature levels, light levels, gas detection, air quality detection, humidity levels, any other suitable statuses, or any combination thereof.

Additionally, the intelligent luminaire 102 may use voice activation services to monitor sound levels (e.g., using the microphone 128) in the environment surrounding the intelligent luminaire 102. By monitoring the sound levels, the intelligent luminaire 102 may be able to detect human presence and distinguish individual voices. The voice detection and distinction may be performed by training the intelligent luminaire 102 to detect and identify occupant voices using the luminaire microphone array (i.e., the microphone 128) that is used in the intelligent luminaire 102 for interacting with voice assistant voice services (e.g., Alexa® by Amazon Technologies, Inc., Google Now and Google Assistant by Google LLC, Cortana® by Microsoft Corporation, Siri® by Apple Inc., any other virtual assistant services, or any combination thereof).

The light system 100 may also include or support communications for other elements or devices at the premises 104, some of which may offer alternative user interface capabilities instead of or in addition to the interactive user interface supported by the intelligent luminaires 102. For example, user interface elements of the light system 100 may be interconnected to the data communication network 116 of the light system 100. Standalone sensors of the lighting system may also be incorporated in the light system 100, where the standalone sensors are interconnected to the data communication network 116. At least some of the standalone sensors may perform sensing functions analogous to those of sensors 127 and 144.

The light system 100 may also support wireless communication to other types of equipment or devices at the premises 104 to allow the other equipment or devices to use the data communication network 116, to communicate with the intelligent luminaires 102, or both. By way of example, one or more of the intelligent luminaires 102 may include the wireless interface 124 for such a purpose. Although shown in the intelligent luminaire 102b, the wireless interface 124 may instead or in addition be provided in any of the other intelligent luminaires 102 in the light system 100. A wireless link offered by the wireless interface 124 enables the light system 100 to communicate with other user interface elements at the premises 104 that are not included within the intelligent luminaires 102. In an example, a wireless controller 146 may represent an additional input device operating as an interface element and a television or monitor 148 may represent an additional output device operating as an interface element. The wireless links to devices like the wireless controller 146 or the television or monitor 148 may be optical, sonic (e.g., speech), ultrasonic, or radio frequency, by way of a few examples.

In some examples the wireless links to the wireless controller 146 or the television or monitor 148 may happen through a wireless router 149 of the data communication network 116. For example, the wireless controller 146 may be communicatively coupled to the wireless router 149, which routes data communications to the intelligent luminaires 102. In some examples, this communication between the wireless controller 146 and the intelligent luminaires 102 may be possible even when the data communication network 116 no longer has connectivity with the wide area network 118.

In an example, the intelligent luminaires 102 are controllable with a wall switch accessory 150 in addition to direct voice control or gesture control provided to the intelligent luminaire 102, as discussed above. The wall switch accessory 150 wirelessly connects to the virtual assistant enabled luminaire or other compatible device using the wireless interface 125. The wireless connection between the wall switch accessory 150 and the intelligent luminaire 102 enables voice and manual control of the luminaire to extend the control range available to the luminaire. In some examples, the wireless controller 146 may be installable within a cradle mounted on the wall to replace or complement the wall switch accessory 150.

A location of the intelligent luminaire 102 may create a situation where the intelligent luminaire 102 is too far from a user to detect audible commands from the user. Additionally, acoustic interference during speaker audio playback may prevent the intelligent luminaire 102 from detecting audio commands from the user. In one or more examples, the location of the intelligent luminaire 102 (e.g., in a ceiling) may not provide the user with physical access to interact with the device to overcome the distance and interference issues associated with detecting the audible commands from the user.

The wall switch accessory 150, the wireless controller 146, or both extend many of the intelligent luminaire features and abilities through a wireless connection. The wall switch accessory 150 and the wireless controller 146 address the physical distance issue by replacing a set of microphones 128 contained in the intelligent luminaire 102 with a set of microphones 128 located at another location within the room. In another example, the wall switch accessory 150 addresses the physical distance issue by adding additional microphones 128 associated with the luminaire at the other location within the room. Further, the wall switch accessory 150 provides a mechanism for the user to press a physical button 152 to instruct the microphones in the wall switch accessory 150 to listen to a voice command.

In an example, the wall switch accessory 150 or the wireless controller 146 may provide a voice stream received at the microphones 128 in the wall switch accessory 150 or the wireless controller 146 to the intelligent luminaire 102 through a Bluetooth connection. In another example, the wall switch accessory 150 or the wireless controller 146 may provide the voice stream to the luminaire through a shared cloud account using Wi-Fi. For example, the wall switch accessory 150 or the wireless controller 146 may provide the voice stream to a cloud account (e.g., a voice service cloud account) through the wireless router 149, and the cloud account processes the voice stream and provides a command or request associated with the voice stream to the intelligent luminaire 102. Other wireless communication protocols are also contemplated for the transmission of the voice stream to the intelligent luminaire 102.

The wall switch accessory 150 or the wireless controller 146 can also instruct the intelligent luminaire 102 to pause or mute audio playback while the voice commands are being communicated. In an example, the wall switch accessory 150 or the wireless controller 146 may have physical buttons (e.g., the button 152) or virtual buttons (e.g., on a display 154 of the wireless controller 146) to allow the user to control features of the intelligent luminaire 102 when the device is unreachable for direct physical interaction. The controllable features of the intelligent luminaire 102 may include increasing or decreasing a speaker volume of the luminaire, pausing or playing music playback through the speaker of the luminaire, muting a speaker output of the luminaire, muting the microphones of the luminaire, the wall switch accessory, or the remote controller for privacy, increasing or decreasing a lamp brightness of the luminaire, changing a lamp color temperature of the luminaire, or turning off the lamp of the luminaire. The physical buttons of the wall switch accessory 150 and the wireless controller 146 or the virtual buttons of the wireless controller 146 that are capable of controlling the controllable features of the intelligent luminaire 102 may perform the control through Bluetooth connections, Wi-Fi connections, or any other suitable wireless communication connections.

Further, other devices may be used in place of the wall switch accessory 150 or the wireless controller 146. For example, the functionality of the wall switch accessory 150 or the wireless controller 146 may be integrated in a device that also controls non-lighting functions. Other functions of the intelligent luminaire 102 may also be provided remotely. For example, lights or other elements used for non-verbal communication may be incorporated as part of the wall switch accessory 150, the wireless controller 146, or other devices that perform similar functions.

The intelligent luminaires 102, as discussed above and shown in the FIG. 1, may include user interface related components for audio and optical (including image) sensing of user input activities. The intelligent luminaire 102 also includes interface related components for audio and visual output to the user. These capabilities of the intelligent luminaires 102 and the light system 100 support an interactive user interface through the lighting devices to control lighting operations, to control other non-lighting operations at the premises, to provide a portal for information access (where the information obtained and provided to the user may come for other equipment at the premises 104 or from network communications with off-premises systems), or any combination thereof.

For example, the intelligent luminaire 102 or the light system 100 can provide a voice recognition/command type interface using the intelligent luminaire 102 or the wireless controller 146 and the data communication network 116 to obtain information, to access other applications or functions, etc. For example, a user at the premises 104 can ask for information such as a stock quote or for a weather forecast for the current location of the premises 104 or for a different location than the premises 104. The user can ask the system to check a calendar for meetings or appointments and can ask the system to schedule a meeting.

In an example, the speech may be detected and digitized in the intelligent luminaire 102 or the wireless controller 146 and is processed to determine that the intelligent luminaire 102 or the wireless controller 146 has received a command or a speech inquiry. For an inquiry, the intelligent luminaire 102 or the wireless controller 146 sends a parsed representation of the speech through the light system 100 (and possibly through the WAN 118) to the server 120 or to a processor within one of the intelligent luminaires 102 or a cradle of the wireless controller 146 with full speech recognition capability. The server 120 identifies the words in the speech and initiates the appropriate action to obtain requested information from an appropriate source via the Internet or to initiate an action associated with the speech. The server 120 sends the information back to the intelligent luminaire 102 (or possibly to another device) with the appropriate output capability, for presentation to the user as an audible or visual output. Any necessary conversion of the information to speech may be done either at the server 120, in the intelligent luminaire 102, or in the cradle of the wireless controller 146, depending on the processing capacity of the intelligent luminaire 102 or the wireless controller 146.

In an example, the intelligent luminaire 102 incorporates artificial intelligence of a virtual assistant. For example, the intelligent luminaire 102 may include functionality associated with voice assistants such as Alexa® by Amazon Technologies, Inc., Google Now and Google Assistant by Google LLC, Cortana® by Microsoft Corporation, Siri® by Apple Inc., any other virtual assistants, or any combination thereof. The virtual assistant enabled functionality of the intelligent luminaire 102 provides voice enabled control of the luminaire lighting features such as a correlated color temperature (CCT) output by the intelligent luminaire 102, lumens output by the intelligent luminaire 102, a configuration of the intelligent luminaire 102, operational modes of the intelligent luminaire 102 (e.g., environmental detection modes, occupancy detection modes, etc.), configuration of any other networked luminaires, any other luminaire lighting feature, or any combination thereof.

Further, in the intelligent luminaires 102 including the speakers 138, the virtual assistant enabled functionality of the intelligent luminaire 102 controls speaker features such as volume, bass, independent channel control, other speaker features, or any combination thereof. The speaker 138 within or associated with the intelligent luminaire 102 may be a speaker element that includes a single speaker or a multiple speaker arrangement. For example, the speaker 138 may be a coaxial loudspeaker with two or more drive units. In such an example, a tweeter may be mounted in front of a subwoofer, and the virtual assistant enabled functionality of the intelligent luminaire 102 is able to control speaker features of both the tweeter and the subwoofer. The speaker 138 may also be a midwoofer-tweeter-midwoofer (MTM) loudspeaker configuration. In the MTM configuration, the virtual assistant enabled intelligent luminaire 102 is able to control speaker features of all three of the drive units (i.e., drive units for the two midwoofers and the tweeter).

The speaker 138 of the intelligent luminaire 102 may be integrated with the intelligent luminaire 102 or be a modular sub-assembly that is capable of being added to or removed from the intelligent luminaire 102. The speaker 138 may include one or more cosmetic pieces to cover the speaker 138 such as a grill or cloth that is acoustically transparent. The cosmetic piece could also be highly reflective in addition to being acoustically transparent. Accordingly, the cosmetic pieces may be installed to balance aesthetic quality, acoustic quality, and light emission quality.

The virtual assistant enabled intelligent luminaire 102 may also include a lens with a beam shaping (e.g., optical distribution) functionality. The virtual assistant may provide control of the intelligent luminaire 102 to control the beam shaping functionality. A lighting element (e.g., the light source 106) of the intelligent luminaire 102 may be a backlight or a waveguide design. Further, the lighting element may be perforated in numerous different arrangements to optimize sound waves that are transmitted through the lighting element from a speaker 138 positioned behind the lighting element.

In an example, the intelligent luminaire 102 may provide a mechanism for non-verbal communication with a user via visual feedback controlled by the virtual assistant. The non-verbal communication may be achieved through accent lighting on a trim ring of the intelligent luminaire 102, or any other lighting features incorporated within the intelligent luminaire 102. For example, the virtual assistant may control the main lighting output of the intelligent luminaire 102 to change colors or change illumination patterns or levels to provide the non-verbal communication to an occupant of a room within the premises 104.

Wireless Controller and Cradle Systems and Operation

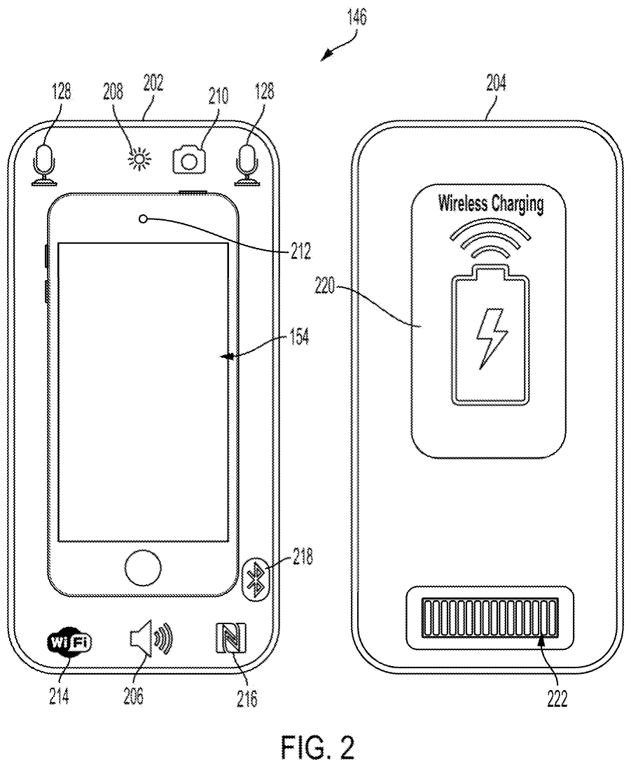

FIG. 2 depicts a schematic representation of a wireless controller 146 of the light system 100, according to certain aspects of the present disclosure. FIG. 2 depicts a representation of a front side 202 and a back side 204 of the wireless controller 146. The front side 202 of the wireless controller 146 includes a display 154. The display 154 may be a touchscreen that displays control features for controlling one or more of the intelligent luminaires 102. For example, the display 154 may display a user interface that includes sliding bars for controlling light intensity output of the intelligent luminaires 102, on/off toggles for the intelligent luminaires 102, lighting color temperature controls of the intelligent luminaires 102, or controls for any other adjustable features of the intelligent luminaires 102.

In some examples, the display 154 may also display a mechanism that activates one or more microphones 128. The microphones 128 may receive voice inputs from a user. The voice inputs may be used to control the intelligent luminaires 102. In one or more examples, the microphones 128 may be activated using a wake word. The wake word may alert the wireless controller 146 to detect and process subsequent speech.

As discussed above with respect to FIG. 1, a location of the intelligent luminaire 102 may create a situation where the intelligent luminaire 102 is too far from a user to detect audible commands from the user. Additionally, acoustic interference during speaker audio playback may prevent the intelligent luminaire 102 from detecting audio commands from the user. In one or more examples, the location of the intelligent luminaire 102 (e.g., in a ceiling) may not provide the user with physical access to interact with the device to overcome the distance and interference issues associated with detecting the audible commands from the user.

The wireless controller 146 extends many of the intelligent luminaire features and abilities through a wireless connection with the intelligent luminaires. The wireless controller 146 addresses the physical distance issue by replacing or complementing a set of microphones 128 contained in the intelligent luminaire 102 with the microphones 128 in the wireless controller 146. In an example, the user may hold the wireless controller 146 and speak directly into the microphones 128.

The front side 202 of the wireless controller 146 may also include a speaker 206 to respond to voice commands received by the microphones 128. Additionally, the wireless controller 146 may include an ambient light sensor 108. The ambient light sensor 108 may provide a mechanism to control a brightness of the display 154. For example, a darker environment may be detected by the ambient light sensor 108 resulting in the brightness of the display 154 being reduced. Likewise, a brighter environment may be detected by the ambient light sensor 108 resulting in the brightness of the display 154 being increased.

A camera 210 may also be included on the wireless controller 146. The camera 210 may enable video communications, such as video calls, through the wireless controller 146 and the intelligent luminaire 102. A status indicator 212 may provide a status update to a user of the wireless controller 146. For example, the status indicator 212 may be vary in color depending on the status of the wireless controller 146. For example, the status indicator 212 may turn blue when a voice input is being detected by the microphones 128. Likewise, the status indicator 212 may turn green when the camera 210 is in use. The status indicator may also flash or blink to provide varying indications of the status of the wireless controller 146.

The wireless controller 146 may include one or more communication modules 214, 216, and 218 to wirelessly communicate with the intelligent luminaire 102. The communication module 214 may provide the wireless controller 146 with the ability to communicate using a Wi-Fi wireless network communication protocol. For example, the wireless controller 146 may communicate through the wireless router 149 of the network 116 to communicate with other devices also communicatively coupled to the network 116. The communication module 216 may provide the wireless controller 146 with the ability to communicate using a near-field communication (NFC) protocol. For example, the wireless controller 146 may wirelessly communicate with another device positioned near the wireless controller 146. Further, the communication module 218 may provide the wireless controller 146 with the ability to communicate using a Bluetooth communication protocol. For example, the wireless controller 146 may communicate directly with other devices within Bluetooth range of the wireless controller 146. Other communication modules may also be used by the wireless controller 146 to facilitate communications using other communication protocols.

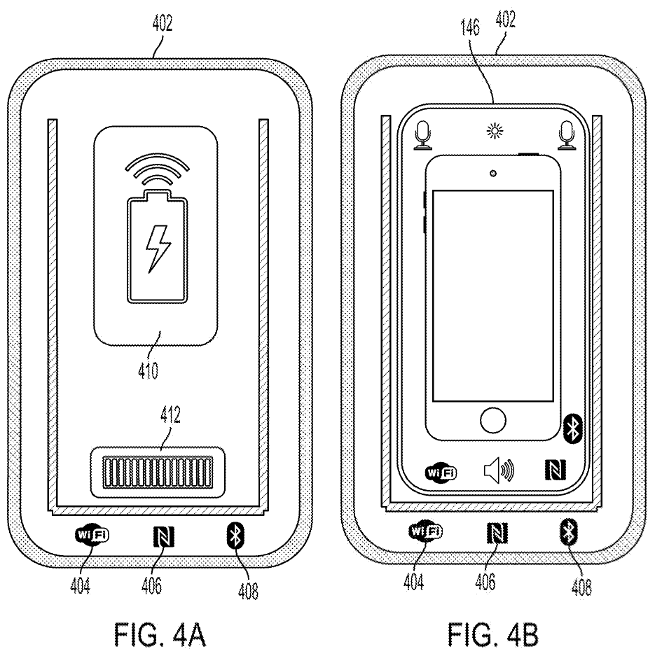

The back side 204 of the wireless controller 146 includes a wireless charging circuit 220, such as a battery trickle charging circuit, that provides the wireless controller 146 with the ability to charge using inductive charging. The wireless controller 146 may be charged through the wireless charging circuit 220 when positioned within a cradle, as described below with respect to FIG. 4. In another example, the wireless controller 146 may use a wireless charging station, such as those used to charge cellular phones and other electronic devices, to inductively charge batteries within the wireless controller 146.

Also provided on the back side 204 of the wireless controller 146 is an electrical interface 222. The electrical interface 222 provides an area where the wireless controller 146 can be hardwired into a data communication path. For example, the electrical interface 222 may mate with a corresponding electrical interface of a cradle of FIG. 4 as a path for updating software in the wireless controller 146 and debugging issues with the wireless controller 146.

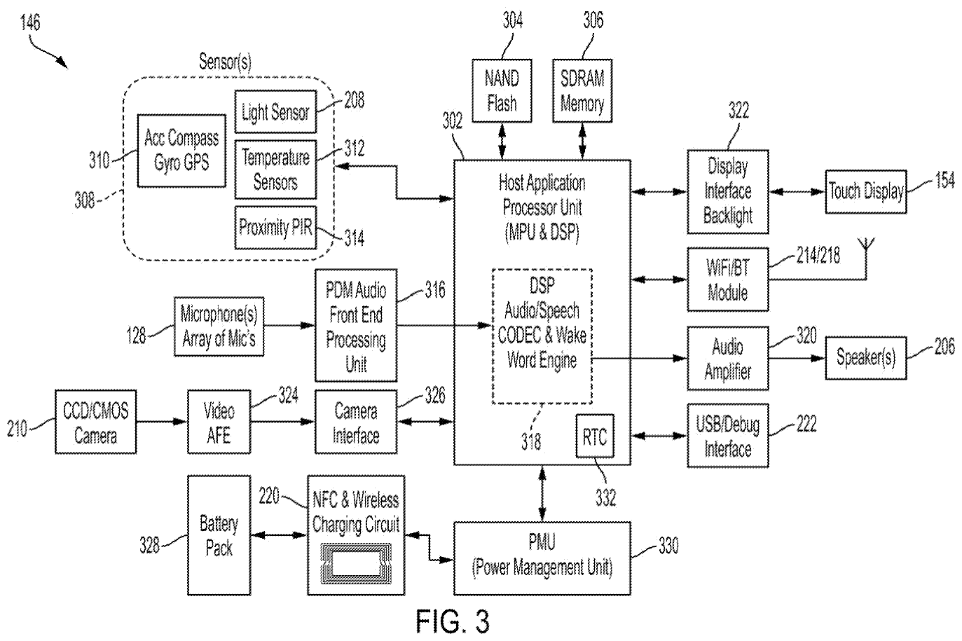

FIG. 3 depicts a block diagram representation of the wireless controller 146, according to certain aspects of the present disclosure. The wireless controller 146 may include a processing unit 302. In an example, the processing unit 302 includes a microprocessor (MPU) and a digital signal processor (DSP). The wireless controller may also include a NAND flash storage 304 and a synchronous dynamic random-access memory (SDRAM) 306. The processing unit 302 may execute instructions stored on the SDRAM 306 and the NAND flash storage 304 to cause the wireless controller 146 to perform operations described herein.

The wireless controller 146 may include a set of one or more sensors 308. The sensors 308 may include positioning sensors 310, such as an accelerometer, a compass, a gyroscope, and a GPS sensor. The sensors 308 may also include the ambient light sensor 208 described above with respect to FIG. 2, temperature sensors 312, and a proximity passive infrared (PIR) sensor 314 (i.e., a motion detector). The sensors 308 may be used to control operation of the wireless controller 146 and the intelligent luminaires 102 controllable by the wireless controller 146. In some examples, the sensors 308 can be used to provide localized control of features in the light system 100. For example, the sensors 308 may enable control of a particular intelligent luminaire 102 located in a closest proximity to the wireless controller 146.

Further, the additional inputs from the sensors 308 may be used by a machine-learning model to learn trends associated with the environment of the light system 100 to generate intelligent commands for controlling the intelligent luminaires 102 in the light system 100. For example, the wireless controller 146, through the machine-learning models executed by the processing unit 302, may learn specific lighting profiles, speaker volumes, or other controllable features of the light system 100 based on conditions sensed by the sensors 308 of the wireless controller 146. Additionally, the machine-learning models may leverage other sensed information obtained by sensors positioned on the intelligent luminaires 102 and communicated to the wireless controller 146.

The array of microphones 128 may feed audio data to a pulse-density modulation (PDM) audio front-end processing unit 316. The front-end processing unit 316 may convert the audio signal from the microphones 128 to a digital representation of the audio signal. The digital representation of the audio signal may be provided to a DSP 318. The DSP 318 may include an audio/speech codec and a wake word engine. The codec may decode the audio signal from the microphones 128 for analysis by the wake word engine. The wake word engine may determine if a user of the wireless controller 146 spoke the wake word. If the user did speak the wake word, the wireless controller 146 may transmit the subsequent audio received by the microphones 128 to a device that is able to process virtual assistant services, such as to the intelligent luminaires 102 or to another voice assistant service. The audio may be transmitted using the Wi-Fi communication module 214 or the Bluetooth communication module 218.

The DSP 318 may also encode audio intended to be output by the wireless controller 146. The encoded audio output may be provided to an audio amplifier 320 for amplification. The amplified audio may be provided to one or more speakers 206 of the wireless controller 146 for output to a user.

The wireless controller 146 also includes the display 154. The ambient light sensor 108 may provide a mechanism to control a brightness of the display 154. For example, a darker environment may be detected by the ambient light sensor 108 resulting in a display interface backlight 322 being controlled by the processor unit 302 to reduce the brightness of the display 154. Likewise, a brighter environment may be detected by the ambient light sensor 108 resulting in the display interface backlight 322 being controlled by the processor unit 302 to increase brightness of the display 154.

The camera 210 of the wireless controller 146 may be a charge-coupled device (CCD), a complementary metal-oxide-semiconductor (CMOS) camera, or any other type of camera device. The camera 210 may interact with a video analog front end (AFE) 324 to condition the image data from the camera 210. The conditioned image data may be provided to a camera interface 326 that may convert the conditioned image data into a digital image. In some examples, the digital image may be displayed on the touch display 154. In addition to or alternative to the touch display 154, the wireless controller 146 may also include physical buttons used to control various aspects of the light system 100.

The wireless controller 146 may include a battery pack 328 that is coupled to the wireless charging circuit 220. The wireless charging circuit 220 may be a battery trickle charging circuit that provides the wireless controller 146 with the ability to charge the battery pack 328 using inductive charging. The wireless controller 146 may be charged through the wireless charging circuit 220 when positioned within a cradle, as described below with respect to FIG. 4. The wireless charging circuit 220 may charge the wireless controller 146 using a near-field communication charging protocol or another wireless charging protocol. Additionally, the wireless charging circuit 220 may provide a pathway for near-field communication with other devices, such as the cradle of FIG. 4. A power management unit 330 may also be coupled to the wireless charging circuit 220 for governing power functions of the wireless controller 146.

The wireless controller 146 may also include a real-time clock (RTC) 332. The RTC 332 may track the current time for the wireless controller 146. The RTC 332 may include an alternate power source, such as a lithium battery or a supercapacitor, such that the RTC 332 can continue to keep the time even when other power sources of the wireless controller 146 are no longer operational.

In an example, the electrical interface 222 of the wireless controller 146 may be a Universal Serial Bus (USB) interface, a cradle electrical connector (as shown in FIG. 2), or any other type of connector capable of mating with a corresponding connector of the cradle of FIG. 4 or other electrical device. The electrical interface 222 may be used in debugging the wireless controller 146. In other examples, the electrical interface 222 may receive power to charge the battery pack 328 or to power the electronic components within the wireless controller 146.

In some examples, the processing unit 302 may execute instructions to perform model training directly on the wireless controller 146. For example, the wireless controller 146 may be trained to perform voice recognition and to learn simple commands relevant to the wireless controller 146 and the light system 100 through machine-learning models. The processing unit 302 may also execute commands for a local voice assistant engine operated directly on the wireless controller 146.

FIG. 4A depicts a schematic representation of a cradle 402 for the wireless controller 146, according to certain aspects of the present disclosure. FIG. 4B depicts a schematic representation of the wireless controller 146 installed within the cradle 402, according to certain aspects of the present disclosure. In an example, the cradle 402 may be mounted on or within a wall within the premises 104. In an additional example, the cradle 402 may include a power cable such that the cradle 402 is positionable on any surface near an electrical outlet.

The cradle 402 may include one or more communication modules 404, 406, and 408 to wirelessly communicate with the intelligent luminaire 102 and with the wireless controller 146. The communication module 404 may provide the cradle 402 with the ability to communicate using a Wi-Fi wireless network communication protocol. For example, the cradle 402 may communicate through the wireless router 149 of the network 116 to communicate with other devices also communicatively coupled to the network 116. The communication module 406 may provide the cradle 402 with the ability to communicate using a near-field communication (NFC) protocol. For example, the cradle 402 may wirelessly communicate with the wireless controller 146 when the wireless controller 146 is docked within the cradle 402. Further, the communication module 408 may provide the cradle 402 with the ability to communicate using a Bluetooth communication protocol. For example, the cradle 402 may communicate directly with other devices within Bluetooth range of the cradle 402. Other communication modules may also be used by the cradle 402 to facilitate communications using other communication protocols.

The cradle 402 includes a wireless charging circuit 410, such as a battery trickle charging circuit, that provides the cradle 402 with the ability to charge the wireless controller 146 using inductive charging when the wireless controller 146 is in near-field communication with the wireless charging circuit 410. For example, the wireless controller 146 may be charged using the wireless charging circuit 410 when positioned within a cradle 402.

Also provided in the cradle 402 is an electrical interface 412. The electrical interface 412 mates with the electrical interface 222 of the wireless controller 146 to provide a hardwired data communication path between the cradle 402 and the wireless controller 146. For example, the electrical interface 412 may provide a data communication path for updating software in the wireless controller 146 and debugging issues with the wireless controller 146.

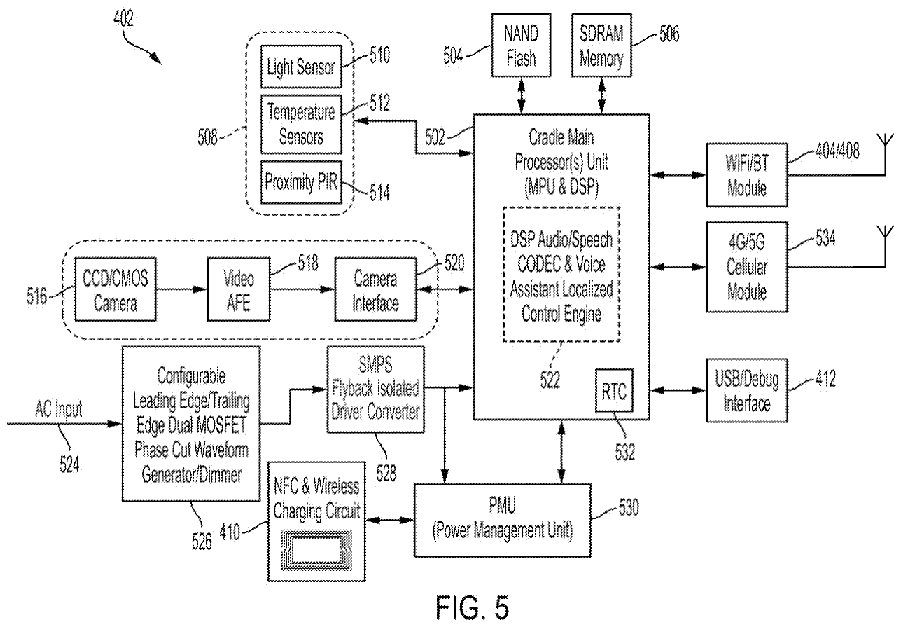

FIG. 5 depicts a block diagram representation of the cradle 402, according to certain aspects of the present disclosure. The cradle 402 may include a processing unit 502. In an example, the processing unit 502 includes a microprocessor (MPU) and a digital signal processor (DSP). The wireless controller may also include a NAND flash storage 504 and a synchronous dynamic random-access memory (SDRAM) 506. The processing unit 502 may execute instructions stored on the SDRAM 506 and the NAND flash storage 504 to cause the cradle 402 to perform operations described herein.

The cradle 402 may include a set of one or more sensors 508. The sensors 508 may include an ambient light sensor 510, temperature sensors 512, and a proximity passive infrared (PIR) sensor 514 (i.e., a motion detector). The sensors 508 may be used to control operation of the cradle 402 and the intelligent luminaires 102 controllable by the wireless controller 146.

A camera 516 of the cradle 402 may be a charge-coupled device (CCD), a complementary metal-oxide-semiconductor (CMOS) camera, or any other camera device. The camera 516 may interact with a video analog front end (AFE) 518 to condition the image data from the camera 516. The conditioned image data may be provided to a camera interface 520 that may convert the conditioned image data into a digital image. In some examples, the digital image may be displayed on the touch display 154 of the wireless controller 146.

In some examples, the processing unit 502 may include a DSP 522. The DSP 522 may include an audio/speech codec and a voice assistant localized control engine. The codec may decode audio signals received at the cradle 402 from the microphones 128 for analysis by the voice assistant localized control engine. The voice assistant localized control engine be able to process certain voice assistant requests from the audio signals locally. That is, the voice assistant localized control engine may receive the audio signals and process certain commands from the audio without sending voice commands of the audio signals to a remote voice assistant processing engine. In other examples, the voice assistant localized control engine may transfer the voice commands to the remote voice assistant processing engine to generate instructions for the cradle 402 to perform in response to the voice commands. For example, the cradle 402 may receive instructions to perform a control operation on one or more of the intelligent luminaires 102 within the premises 104.

The DSP 522 may also encode audio intended to be output by the wireless controller 146. The encoded audio output may be provided to the wireless controller 146, to one or more of the intelligent luminaires 102, or to any other device with a speaker that is communicatively coupled to the light system 100. The encoded audio may be provided to one or more speakers for output to a user.

An AC input 524 to the cradle 402 may be a power source for operations of the components of the cradle 402. In an example, the AC input 524 may be the mains power source of a facility. The AC input 524 may be fed into a configurable phase cut waveform generator 526 when legacy wiring for the lighting system 100 is present. In some examples, the waveform generator 526 may be bypassed when the legacy wiring for the lighting system is not present. In an example, the waveform generator 526 may be a leading edge or trailing-edge, dual-MOSFET, phase-cut waveform dimmer used to control dimming operations of a legacy lighting system.

In an example, the waveform generator 526 may supply a waveform to a switched-mode power supply (SMPS) flyback isolated driver converter 528. The driver converter 528 may convert the AC power signals from the waveform generator 526 to a DC power supply for use by the cradle 402. Additionally, the DC power supply may be provided to a power management unit 530 of the cradle 402 for governing power functions of the cradle 402. In some examples, the AC input 524, the waveform generator 526, and the driver converter 528 may be replaced by a battery power source the provides a DC power supply directly to the power management unit 530 of the cradle 402. Further, the cradle 402 may include a battery power source that is able to operate in addition to the AC input 524, such as when a power outage occurs.

The cradle 402 may include the wireless charging circuit 410 that is able to provide a charging power to the wireless charging circuit 220 of the wireless controller 146. The wireless charging circuit 410 may be a battery trickle charging circuit that provides the cradle 402 with the ability to charge the battery pack 328 of the wireless controller 146 using inductive charging. Additionally, the wireless charging circuit 410 may provide a pathway for near-field communication with other devices, such as the wireless controller 146 when docked within the cradle 402. The power management unit 530 may also be coupled to the wireless charging circuit 410 for governing power functions of the wireless charging circuit 410.

The cradle 402 may also include a real-time clock (RTC) 532. The RTC 532 may track the current time for the cradle 402. The RTC 532 may include an alternate power source, such as a lithium battery or a supercapacitor, such that the RTC 532 can continue to keep the time even when other power sources of the cradle 402 are no longer operational.

In an example, the electrical interface 412 of the cradle 402 may be a Universal Serial Bus (USB) interface, a cradle electrical connector (as shown in FIG. 4), or any other type of connector capable of mating with a corresponding electrical interface 222 of the wireless controller 146 or other electrical device. The electrical interface 412 may be used in debugging the wireless controller 146. In other examples, the electrical interface 412 may provide power to charge the battery pack 328 of the wireless controller 146 or to power the electronic components within the wireless controller 146.

The cradle 402 may use the Wi-Fi communication module 404, the Bluetooth communication module 408, a 4G or 5G cellular module 534, or any combination thereof to communicate with other devices. For example, the cradle 402 may communicate with other devices using the Bluetooth communication module 404 when the other devices are within a Bluetooth range of the cradle 402. If the devices our outside of Bluetooth range, the cradle 402 may communicate using the Wi-Fi communication module 404 or the cellular module 534 to communicate with the other devices.

In some examples, the cradle 402 may prioritize various communication modules 404, 408, and 534. For example, the cradle 402 may first attempt to communicate with other devices using the Bluetooth module 404. If no devices are within a Bluetooth communication range of the cradle 402, the cradle 402 may then attempt to communicate using the Wi-Fi communication module 404. If a desired device is not available for communication using Bluetooth or Wi-Fi, then the cradle 402 may communicate with other devices using the cellular module 534. Other prioritizations of the communication modules 404, 408, and 534 are also contemplated.

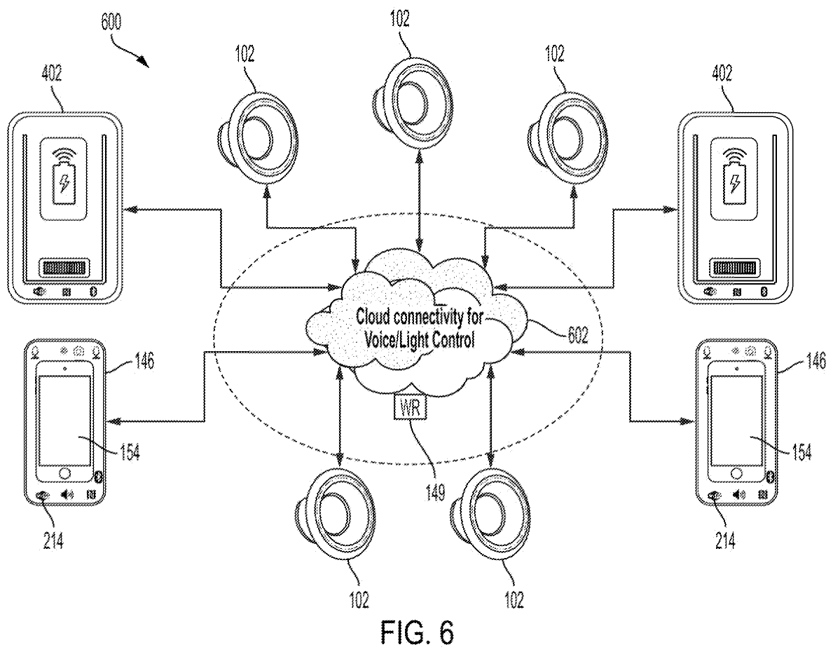

FIG. 6 depicts a diagram of a group 600 of compatible connected fixtures using cloud connectivity 602 for voice and lighting control, according to certain aspects of the present disclosure. In an example, the cloud connectivity 602 may enable the intelligent luminaires 102 to communicate with the cradles 402 and the wireless controllers 146. For example, the wireless controllers 146 may receive an input from a user, such as a voice command, to control the intelligent luminaires 102 or to obtain information for display on the displays 154. The wireless controllers 146 may transmit the voice command to the wireless router 149, which is communicatively coupled with the cloud connectivity 602, using the Wi-Fi communication module 214. The voice command may be received at a cloud server for interpretation and acknowledgment. After interpretation, the cloud server may transmit control signals, using the cloud connectivity 602, to control the intelligent luminaires 102 or the wireless controller 146. When an internet connection is established at the wireless router 149, communication between the devices may all be accomplished using a Wi-Fi PHY/MAC layer of a router network established by the wireless router 149. In other words, the communication devices may communicate using the router network even when the router lacks internet connectivity.

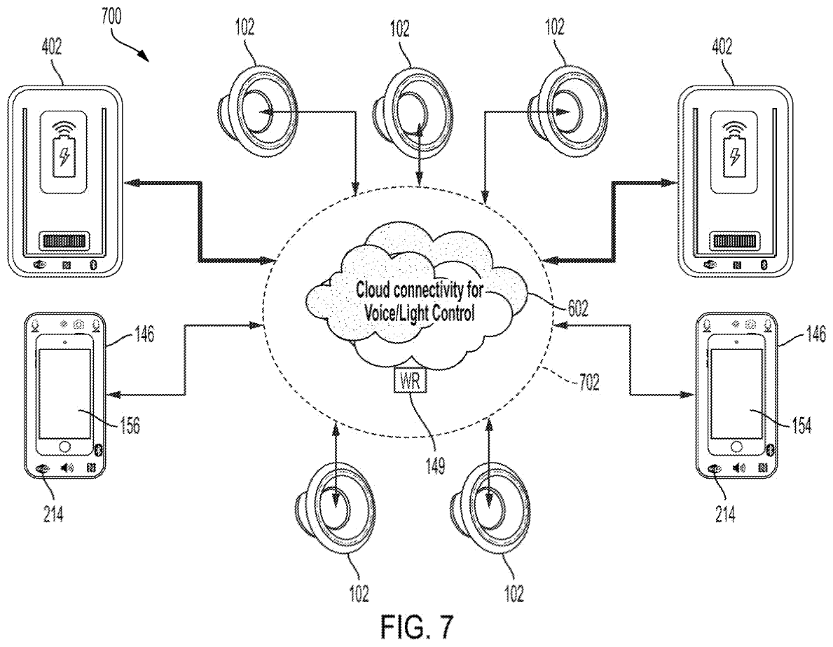

FIG. 7 depicts a diagram of a group 700 of compatible connected fixtures using localized control 702, according to certain aspects of the present disclosure. In an example, the localized control 702 may enable the intelligent luminaires 102 to communicate with the cradles 402 and the wireless controllers 146 when the cloud connectivity 602 is not available. For example, the wireless router 149 may be functional, but the wireless router 149 may lack internet connectivity. In such an example, the wireless controllers 146 may receive an input from a user, such as a voice command, to control the intelligent luminaires 102 or to obtain information for display on the displays 154. The wireless controllers 146 may transmit the voice command to the wireless router 149, which lacks internet connectivity, using the Wi-Fi communication module 214. Because the wireless router 149 lacks internet connectivity, the voice command may be received at the cradle 402 for interpretation and acknowledgment. In some examples, the cradle 402 may include sufficient voice control intelligence to decipher a limited number of voice commands relating to the lighting system 100. For example, the voice command to turn on or to dim the intelligent luminaires 102 may be decipherable by the cradle 402, or the voice command to display the current light settings of the intelligent luminaires on the display 154 may be decipherable by the cradle 402. After interpretation, the cradle 402 may transmit control signals across the localized control 702 to control the intelligent luminaires 102 or the wireless controller 146.

In additional examples, the wireless controller 146 may also be capable of deciphering basic lighting control voice commands locally. In such an example, the wireless controller 146 may decipher a voice command to dim the lights and transmit a control signal directly to the intelligent luminaires 102 using the localized control 702. When no internet connection is established at the wireless router 149, the communication between the devices may all be accomplished across the localized control 702 using the Wi-Fi PHY/MAC layer of the router network despite not having internet connectivity.

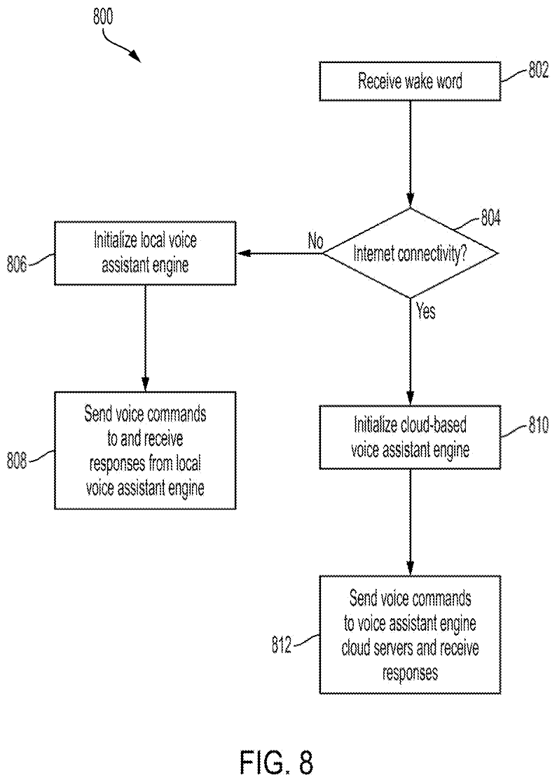

FIG. 8 depicts an example of a process 800 for performing voice control operations on the light system 100, according to certain aspects of the present disclosure. At block 802, the process 800 involves receiving a wake word at the wireless controller 146. In an example, a wake word engine of the wireless controller 146 may recognize that a user is attempting to provide a voice command for the light system 100. Upon detecting the wake word, the wireless controller 146 may prepare for receiving a subsequent voice command from the user.

At block 804, the process 800 involves determining if the wireless controller 146 has internet access. For example, the wireless router 149 at the premises 104 may or may not be connected to the internet. If the wireless router 149 is not connected to the internet, at block 806, the process 800 involves initializing a local voice assistant engine. the local voice assistant engine may be located within the wireless controller 146 or within the cradle 402. In an example where the local voice assistant engine is located within the cradle 402, the wireless controller 146 may transmit the voice command across the Wi-Fi PHY/MAC layer of the router network to the cradle 402. The local voice assistant engine may perform voice recognition processes, voice recognition training processes, command training processes, or any other training or recognition techniques that may be used to ultimately control the intelligent luminaires 102. In some examples, the training techniques may include machine-learning techniques for voice recognition and training.

At block 808, the process 800 involves sending voice commands to and receiving responses to the voice commands from the local voice assistant engine. The responses to the voice commands may be received at the intelligent luminaires 102, for example, as control signals for controlling a light or audio output from the intelligent luminaires 102. The responses to the voice commands may also be received at the remote controller 146. For example, the response may include control signals for controlling an audio or visual output of the remote controller 146. In some examples, due to the limited functionalities of the local voice assistant engine compared to a cloud-based voice assistant engine, the local voice assistant engine may provide an indication to the remote controller 146 that the request exceeds an operational ability of the local voice assistant engine. In such an example, the local voice assistant engine may provide the remote controller 146 with a list of functionalities available for the local voice assistant engine to perform, and the remote controller 146, or other communication device, may provide the list of available functionalities to a user of the remote controller 146.

If the wireless controller 146 is determined to have internet access at block 804, then, at block 810, the process 800 involves initializing a cloud-based voice assistant engine. Initializing the cloud-based voice assistant engine may involve preparing the cloud-based voice assistant engine for receiving a voice command from the wireless controller 146.

At block 812, the process 800 involves sending voice commands to and receiving responses to the voice commands from voice assistant engine cloud servers. The responses to the voice commands may be received at the intelligent luminaires 102, for example, as control signals for controlling a light or audio output from the intelligent luminaires 102. The responses to the voice commands may also be received at the remote controller 146. For example, the response may include control signals for controlling an audio or visual output of the remote controller 146.

In some examples, the process 800 may involve sending some voice commands to the cloud-based voice assistant engine for processing, while also processing some voice commands locally at the local voice assistant engine. For example, complex voice requests (e.g., asking for information unrelated to the light system 100) may be transmitted to the cloud-based voice assistant engine, while simple voice requests (e.g., asking for the intelligent luminaires 102 to turn on or off) may be resolved at the local voice assistant engine to avoid any lag associated with transmitting the voice request to the cloud-based voice assistant engine.

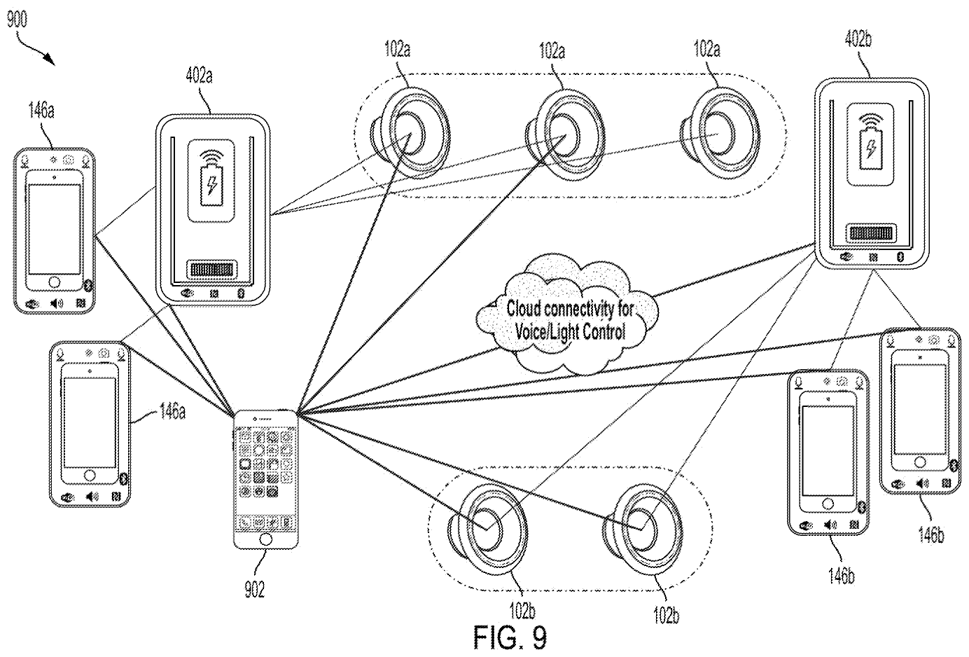

FIG. 9 depicts a diagram 900 of a group of compatible connected fixtures using peer-to-peer and device-to-device communication for lighting control, according to certain aspects of the present disclosure. In an example, a mobile device 902 may communicate with the cradles 402a and 402b, the wireless controllers 146a and 146b, and the intelligent luminaires 102a and 102b using a Wi-Fi communication protocol through a wireless router network of the premises 104. That is, the mobile device 902 may communicate with the depicted devices when the mobile device 902 is operating on the same wireless router network.

In an additional examples, a Bluetooth communication protocol may be used for device-to-device communication within the premises 104. For example, the wireless controllers 146a and 146b may communicate with the cradles 402a and 402b using the Bluetooth communication protocol. In one or more examples, the location of the wireless controllers 146a and 146b within the premises 104 may dictate with which of the cradles 402a and 402b the wireless controllers 146a and 146b communicate. For example, the wireless controllers 146a may be within Bluetooth range of the cradle 402a and out of range of the cradle 402b. Likewise, the wireless controllers 146b may be within Bluetooth range of the cradle 402b and out of range of the cradle 402a.

Upon receiving control instructions from the wireless controllers 146a and 146b, the cradles 402a and 402b may communicate with the intelligent luminaires 102a and 102b. In some examples, the cradles 402a and 402b may be associated with a particular group of intelligent luminaires 102a and 102b. In such an example, the wireless controller 146a may be within Bluetooth range of the cradle 402a associated with the particular group of intelligent luminaires 102a for the wireless controller 146a to control the particular group of intelligent luminaires 102a. Likewise, the wireless controller 146b may be within Bluetooth range of the cradle 402b associated with the particular group of intelligent luminaires 102b for the wireless controller 146b to control the particular group of intelligent luminaires 102b.

The intelligent luminaires 102 may also transmit data to the cradles 402 using the Bluetooth communication protocol and to the mobile device 902 using the Wi-Fi communication protocol. For example, when the intelligent luminaire 102 receives a voice command, the intelligent luminaire 102 may transmit the voice command to the cradle 402 or the mobile device 902 for further processing or transfer to the voice assistant cloud servers. The intelligent luminaires 102 may also transmit data from sensors in the intelligent luminaires 102 to the cradles 402 using the Bluetooth communication protocol or the mobile device 902 using the Wi-Fi communication protocol.

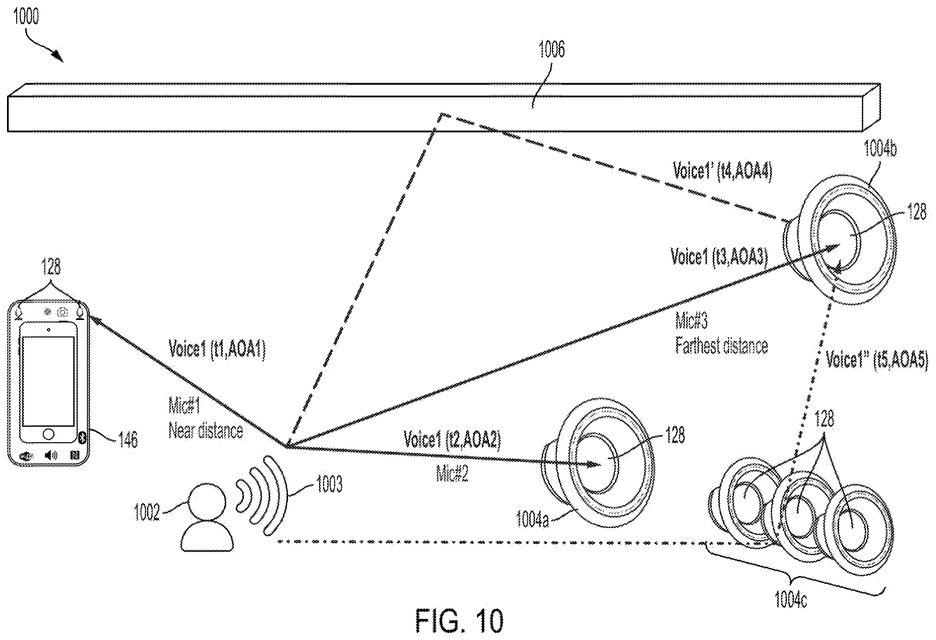

FIG. 10 depicts a diagram 1000 of distributed microphones 128 for far field barge-in performance improvement, according to certain aspects of the present disclosure. In an example, a user 1002 may speak a voice command 1003 intended to control an operation of intelligent luminaires 1004. In an example, the voice command 1003 may be received at various times at varying microphones 128 based on how close the microphones 128 are to the user 1002. For example, the microphones 128 of the wireless controller 146 may receive the voice command 1003 at time t1, the microphone 128 of the intelligent luminaire 1004a may receive the voice command 1003 at time t2, and the microphone 128 of the intelligent luminaire 1004b may receive the voice command 1003 at time t3. The time t1 may be shorter than the time t2 and t3, and the time t2 may be shorter than the time t3. The time lengths are based on how close the user 1002 is to the microphones 128.

In an example, the intelligent luminaire 1004b may include a voice assistant module used for processing the voice command 1003, while the intelligent luminaire 1004a and the wireless controller 146 lack the voice assistant module. In such an example, the intelligent luminaire 1004b may be the barge-in unit for receiving voice commands. Because the barge-in unit may be located at a distance from the user 1002 that exceeds or is at the limit of the barge-in capabilities, the microphones 128 of the wireless controller 146 and the intelligent luminaire 128 may form a distributed microphone system to assist in the barge-in operation. For example, the microphones 128 of the wireless controller 146 and the intelligent luminaire 128 may receive a wake word used for the barge-in operation at an earlier time than the intelligent luminaire 1004b, and the intelligent luminaire 1004b may rely on the voice command 1003 received at the microphones 128 that are determined to be closest to the user 1002 (e.g., at the wireless controller 146 in this instance). This distributed microphone system may greatly increase the barge-in range and performance of the intelligent luminaire 1004b compared to only the intelligent luminaire 1004b providing the barge-in functionality.

In an example, a cluster of intelligent luminaires 1004c may receive the wake word or the voice command 1003 from the user, and the cluster of intelligent luminaires 1004c may forward the wake word or the voice command 1003 to the intelligent luminaire 1004b at time t5. In some examples, the voice command 1003 may be provided from the intelligent luminaires 1004c to the intelligent luminaire 1004b through the cloud-based voice assistant engine. By receiving the voice commands 1003 at varying times from varying locations, the intelligent luminaire 1004b may verify the content of the voice commands 1003 when the signal received directly at the microphone 128 of the intelligent luminaire 1004b is weak due to a distance from the user 1002 or echoes of the voice command 1003 from walls or ceilings. In some examples, the use of the distributed microphone system may also prevent voice echoes, such as when the voice command 1003 echoes off of a ceiling 1006, from interfering with the barge-in operation.

Further, microphone arrays represented by the microphones 128 in the intelligent luminaires 1004a, 1004b, and 1004c and in the wireless controller 146 may be able to detect an angle of arrival of the voice command 1003 at each device (e.g., AOA1, AOA2, AOA3, AOA4, AOA5). Through the detected angles of arrival, the light system 100 including the intelligent luminaires 1004a, 1004b, and 1004c and the wireless controller 146 may be able to detect a location of the user 1002 within the premises of the light system 100. The detected angles of arrival may also be used to identify and remove signals resulting from echoes.

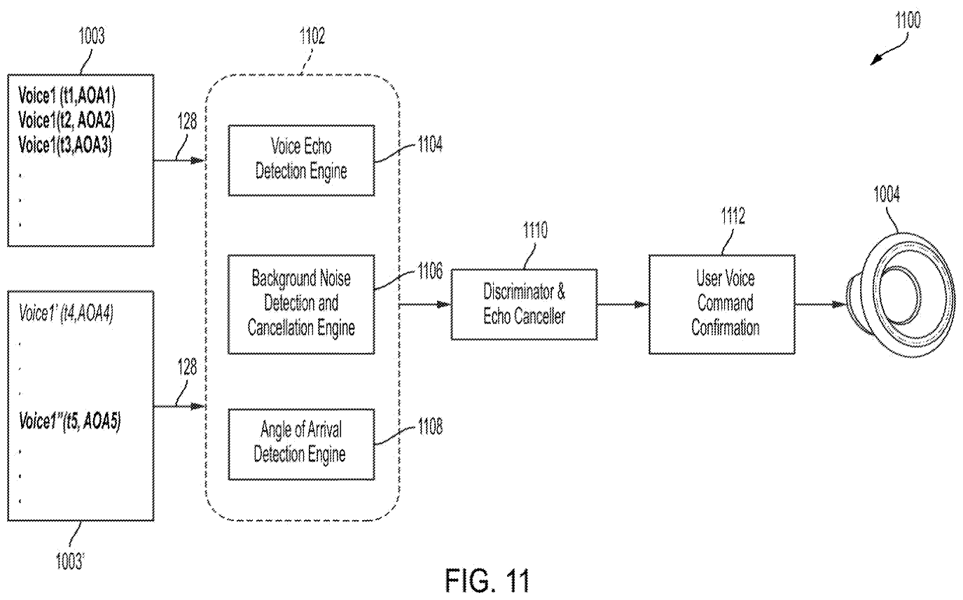

FIG. 11 depicts a data flow 1100 of far field barge-in, according to certain aspects of the present disclosure. The microphones 128 may detect the voice command 1003 at different times based on the proximity of the individual microphones 128 to the user 1002 issuing the voice command 1003. The microphones 128 may also detect echoed voice command 1003′ that result from the voice command 1003 reflecting off of various surfaces. A voice processing unit 1102 may receive the voice command 1003 and the echoed voice command 1003′ from the microphones 128.

The voice processing unit 1102 may include a voice echo detection engine 1104, a background noise detection and cancellation engine 1106, and an angle of arrival detection engine 1108. The voice processing unit 1102 may use these engines 1104-1108 to process the voice command 1003 and the echoed voice command 1003′ received at the microphones 128 to detect the echo, to detect and cancel the background noise, and to detect the angle of arrival of the voice command 1003 at the microphones 128.

After processing is completed at the voice processing unit 1102, a discriminator and echo canceller 1110 may cancel the echo detected by the voice echo detection engine 1104. With the echo and background noise canceled, a voice command confirmation module 1112 may confirm content of the voice command 1003. Upon completion of the voice command confirmation, the intelligent luminaire 1004b (e.g., the barge-in unit) may perform an operation based on the received and confirmed voice command 1003.

### GENERAL CONSIDERATIONS

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more aspects of the present subject matter. Any suitable programming, scripting, or other type of language or combinations of languages may be used to implement the teachings contained herein in software to be used in programming or configuring a computing device.

Aspects of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific aspects thereof, it will be appreciated that those skilled in the art, upon attaining an understanding of the foregoing, may readily produce alterations to, variations of, and equivalents to such aspects. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

What is claimed is:

1. A wireless controller system, comprising:
a cradle device, comprising:
a power input configured to receive power from a power source;
a first communication module configured to communicate wirelessly with one or more devices remote from the cradle device; and
a first electrical interface configured to provide a charging power to a wireless controller; and
the wireless controller, comprising:
a display device configured to display lighting system control features;
a second communication module configured to communicate wirelessly with the first communication module of the cradle device;
a microphone configured to receive a voice input to interact with at least one voice assistant; and
a second electrical interface configured to generate a power link with the first electrical interface of the cradle device to receive the charging power from the cradle device.

2. The wireless controller system of claim 1, wherein the cradle device further comprises:
a processor; and
a non-transitory memory device communicatively coupled to the processor comprising instructions that are executable by the processor to perform operations comprising:
receiving a representation of the voice input at the cradle device from the wireless controller;
detecting internet connectivity of the cradle device;
in response to detecting internet connectivity, sending voice commands to a remote voice assistant engine of the at least one voice assistant; and
in response to detecting no internet connectivity, processing voice commands using a local voice assistant engine of the cradle device, wherein at least one intelligent luminaire is controlled using a response to the voice input from the remote voice assistant engine or the local voice assistant engine.

3. The wireless controller system of claim 1, wherein the second communication module of the wireless controller is configured to send a digital representation of the voice input to the first communication module of the cradle device across a Wi-Fi PHY/MAC layer of a wireless router network.

4. The wireless controller system of claim 1, wherein the cradle device is configured to wirelessly transmit control commands using a Bluetooth communication protocol to at least one intelligent luminaire based on the voice input received at the wireless controller.

5. The wireless controller system of claim 1, wherein the wireless controller is configured to receive the charging power at the second electrical interface from the first electrical interface using near-field communication charging or another wireless charging protocol.

6. The wireless controller system of claim 1, wherein the wireless controller further comprises:
a processor; and
a non-transitory memory device communicatively coupled to the processor comprising instructions that are executable by the processor to perform operations comprising:
receiving a wake word at the microphone; and
providing barge-in functionality for an intelligent luminaire.

7. The wireless controller system of claim 1, wherein the cradle device further comprises:
a local voice assistant engine configured to receive the voice input from the wireless controller, wherein the cradle device is configured to control at least one intelligent luminaire using a response to the voice input generated by the local voice assistant engine.

8. The wireless controller system of claim 1, wherein the cradle device further comprises:
a third communication module configured to communicate wirelessly with at least one intelligent luminaire to control operation of the at least one intelligent luminaire, wherein the third communication module comprises a Wi-Fi communication module, a Bluetooth communication module, a cellular communication module, or a combination thereof.

9. A wireless controller, comprising:
a display device configured to display lighting system control features;
a communication module configured to communicate wirelessly with one or more devices remote from the wireless controller;
at least one sensor configured to sense at least one environmental condition at the wireless controller;
a processor, and
a non-transitory memory device communicatively coupled to the processor comprising instructions that are executable by the processor to perform operations comprising:
receiving an indication of the at least one environmental condition from the at least one sensor; and
automatically controlling at least one intelligent luminaire using the indication of the at least one environmental condition from the at least one sensor.

10. The wireless controller of claim 9, wherein the at least one sensor comprises at least one microphone and the at least one environmental condition comprises a voice input received at the at least one microphone to interact with at least one voice assistant, and wherein the instructions are further executable by the processor to perform operations comprising:
detecting internet connectivity of the wireless controller;
in response to detecting internet connectivity, sending the voice input to a remote voice assistant engine of the at least one voice assistant; and
in response to detecting no internet connectivity, sending the voice input to a local voice assistant engine of the at least one voice assistant, wherein the operation of automatically controlling the at least one intelligent luminaire is performed using a response to the voice input from the remote voice assistant engine or the local voice assistant engine.

11. The wireless controller of claim 10, wherein sending the voice input to the local voice assistant engine comprises sending the voice input across a Wi-Fi PHY/MAC layer of a wireless router network.

12. The wireless controller of claim 9, wherein the instructions are further executable by the processor to perform operations comprising:
wirelessly transmitting control commands to the at least one intelligent luminaire, wherein the control commands are transmitted using a Bluetooth communication protocol.

13. The wireless controller of claim 9, wherein the at least one sensor comprises at least one microphone, and wherein the instructions are further executable by the processor to perform operations comprising:
receiving a wake word at the at least one microphone; and
providing barge-in functionality at the wireless controller for the at least one intelligent luminaire.

14. The wireless controller of claim 9, further comprising:
a first electrical interface configured to electrically and communicatively couple with a second electrical interface of a cradle device, wherein the first electrical interface is configured to provide a hard-wired data communication path to the cradle device while the wireless controller is cradled in the cradle device.

15. The wireless controller of claim 9, wherein the at least one sensor comprises an accelerometer, a compass, a gyroscope, a GPS sensor, an ambient light sensor, a temperature sensors, a proximity passive infrared (PIR) sensor, or any combination thereof, and wherein the operation of automatically controlling the at least one intelligent luminaire is performed by applying a machine-learning model to the indication of the at least one environmental condition to generate a lighting control signal that controls the at least one intelligent luminaire.

16. A cradle device, comprising:
a power input configured to receive power from a power source;
a first communication module configured to communicate wirelessly with at least one wireless controller remote from the cradle device;
a second communication module configured to communicate wirelessly with at least one intelligent luminaire to control operation of the intelligent luminaire; and
a first electrical interface configured to provide a charging power to the at least one wireless controller.

17. The cradle device of claim 16, further comprising:
a third communication module configured to communicate wirelessly with at least one cloud computing service comprising a remote voice assistant engine.

18. The cradle device of claim 17, wherein the third communication module comprises a Wi-Fi communication module, a Bluetooth communication module, a cellular communication module, or a combination thereof.

19. The cradle device of claim 16, wherein the first electrical interface comprises a wireless charging circuit configured to provide the charging power to the at least one wireless controller while the at least one wireless controller is in near-field communication with the first electrical interface.

20. The cradle device of claim 16, further comprising:
a local voice assistant engine configured to receive voice commands from the at least one wireless controller, wherein the cradle device is configured to control at least one intelligent luminaire using a response to the voice commands generated by the local voice assistant engine.
